(19) United States
(12) Patent Application Publication
(10) Pub. No.: US 2026/0031741 A1
(43) Pub. Date: Jan. 29, 2026

(54) POWER SUPPLY SYSTEM AND CONTROL METHOD THEREOF

(71) Applicant: DELTA ELECTRONICS, INC., Taoyuan City (TW)

(72) Inventors: Deng-Cyun HUANG, Taoyuan City (TW); Chin-Te KU, Taoyuan City (TW); Yi-Hsun CHIU, Taoyuan City (TW); Wei-Hsin WEN, Taoyuan City (TW); Chia-Hsiong HUANG, Taoyuan City (TW)

(21) Appl. No.: 19/212,719

(22) Filed: May 20, 2025

Related U.S. Application Data
(60) Provisional application No. 63/676,446, filed on Jul. 29, 2024.

(30) Foreign Application Priority Data
Mar. 4, 2025 (CN) 202510248277.4

(51) Int. Cl. H02M 7/12; H02M 1/32; H02M 7/219

(52) U.S. Cl. CPC H02M 7/125; H02M 1/32; H02M 7/219

(57) ABSTRACT

A power supply system for converting three-phase AC voltages to DC output voltages includes a first capacitor and a second capacitor, three bridge arm circuits, a protection circuit, a voltage detection circuit and a control circuit. The protection circuit includes a current-limiting element electrically connected in series with the first capacitor and the second capacitor and a bypass circuit connected in parallel with the current-limiting element. The voltage detection circuit is configured to detect a voltage across the current-limiting element. When the voltage is greater than a predetermined value, the control circuit sets the bypass circuit to be not conducted, such that the protection circuit conducts current through the current-limiting element. When the voltage is less than the predetermined value, the control circuit sets the bypass circuit to be conducted, such that the protection circuit conducts current through the bypass circuit.

### CROSS-REFERENCE TO RELATED APPLICATION

This application claims priority to U.S. Provisional Application Ser. No. 63/676,446, filed on Jul. 29, 2024 and Chinese patent application Serial Number 202510248277.4, filed on Mar. 4, 2025, which are herein incorporated by reference in its entirety.

### BACKGROUND

### Technical Field

The present disclosure relates to a power supply system, and more particularly to a power supply system with an inrush current protection function.

### Description of Related Art

In a current power supply system, to suppress an inrush current, an inrush protection circuit is typically disposed between an AC input terminal and a boost inductor. As required input and output power increases, an input current correspondingly rises significantly, necessitating larger or more inrush protection circuits to suppress a larger inrush current on an AC side. This will result in an increased occupied space of the power supply system and a decrease in power density, so that the power supply system is difficult to provide the required power output within a limited space.

Therefore, how to provide a power supply system to addresses the aforementioned issue is an important topic in the art.

### SUMMARY

The present disclosure provides a power supply system for converting three-phase AC voltages to DC output voltages. The power supply system comprises a first output terminal, a second output terminal, a first capacitor, a second capacitor, three bridge arm circuits, a protection circuit, a voltage detection circuit, and a control circuit. The first capacitor and the second capacitor are electrically connected in series between the first output terminal and the second output terminal. The three bridge arm circuits are connected in parallel between a first DC terminal and a second DC terminal, each of the bridge arm circuits having an input point for receiving one of the three-phase AC voltages and electrically connected to a neutral point between the first capacitor and the second capacitor. The protection circuit is electrically connected in series with the first capacitor and the second capacitor between the first DC terminal and the second DC terminal, wherein the protection circuit comprises a current-limiting element and a bypass circuit. The current-limiting element is electrically connected in series with the first capacitor and the second capacitor. The bypass circuit is connected in parallel with the current-limiting element. The voltage detection circuit is configured to detect a voltage across the current-limiting element. The control circuit is electrically connected to the voltage detection circuit and the protection circuit. The control circuit is configured to perform the following steps: when the voltage is greater than a predetermined value, setting, by the control circuit, the bypass circuit to be not conducted, such that the protection circuit conducts current through the current-limiting element; and when the voltage is less than the predetermined value, setting, by the control circuit, the bypass circuit to be conducted, such that the protection circuit conducts current through the bypass circuit.

The present disclosure provides a control method of a power supply system. The power supply system comprises a first output terminal and a second output terminal; a first capacitor and a second capacitor electrically connected in series between the first output terminal and the second output terminal; three bridge arm circuits connected in parallel between a first DC terminal and a second DC terminal; a protection circuit electrically connected in series with the first capacitor and the second capacitor between the first DC terminal and the second DC terminal; a voltage detection circuit; and a control circuit electrically connected to the voltage detection circuit and the protection circuit, wherein each of the bridge arm circuits has an input point for electrically connecting one of the three-phase AC voltages, wherein each of the bridge arm circuits is electrically connected to a neutral point between the first capacitor and the second capacitor, wherein the protection circuit comprises a current-limiting element electrically connected in series with the first capacitor and the second capacitor and a bypass circuit connected in parallel with the current-limiting element. The control method comprises the following steps: when a voltage across the current-limiting element is greater than a predetermined value, setting, by the control circuit, the bypass circuit to be not conducted, such that the protection circuit conducts current through the current-limiting element; and when the voltage is less than the predetermined value, setting, by the control circuit, the bypass circuit to be conducted, such that the protection circuit conducts current through the bypass circuit.

The present disclosure provides a power supply system. The power supply system is configured to convert three-phase AC voltages to DC output voltages. The power supply system comprises a first output terminal, a second output terminal, a first capacitor, a second capacitor, three bridge arm circuits, a protection circuit, a control circuit, and an auxiliary power converter. The first capacitor and the second capacitor are electrically connected in series between the first output terminal and the second output terminal. The three bridge arm circuits are connected in parallel between a first DC terminal and a second DC terminal, each of the bridge arm circuits has an input point for electrically connecting one of the three-phase AC voltages and electrically connected to a neutral point between the first capacitor and the second capacitor. The protection circuit is electrically connected in series with the first capacitor and the second capacitor between the first DC terminal and the second DC terminal. The protection circuit comprises a current-limiting element and a bypass circuit. The current-limiting element is electrically connected in series with the first capacitor and the second capacitor. The bypass circuit is connected in parallel with the current-limiting element. The control circuit is electrically connected to the protection circuit. The auxiliary power converter is electrically connected to the control circuit and configured to convert the three-phase AC voltage to supply power to the control circuit. The control circuit starts to measure a duration when receiving the three-phase AC voltages; when the duration is less than a predetermined period, the control circuit sets the bypass circuit to be not conducted, such that the protection circuit conducts current through the current-limiting element; and when the duration is greater than the predetermined period, the control circuit sets the bypass circuit to be conducted, such that the protection circuit conducts current through the bypass circuit.

In summary, the power supply system according to the present disclosure can suppress inrush currents, and due to a higher voltage on a DC side and a smaller current flowing through the DC side, the selected specifications and quantity of devices in the protection circuit can be reduced, thereby reducing the volume of the system, increasing the power density, and lowering the costs.

### BRIEF DESCRIPTION OF THE DRAWINGS

To make the above and other objectives, features, advantages, and embodiments of the present disclosure more apparent and understandable, the descriptions of the accompanying drawings are as follows:

FIG. 1A is a schematic diagram of a power supply system according to some embodiments of the present disclosure;

FIG. 1B is a schematic diagram of a power supply system according to some embodiments of the present disclosure;

FIG. 1C is a schematic diagram of a power supply system according to some embodiments of the present disclosure;

FIG. 2 is a schematic diagram of a bridge arm circuit of a power supply system according to some embodiments of the present disclosure;

FIG. 3 is a schematic diagram of a bridge arm circuit of a power supply system according to some embodiments of the present disclosure;

FIG. 4 is a schematic diagram of a power supply system according to some embodiments of the present disclosure; and

FIG. 5 is a schematic diagram of a power supply system according to some embodiments of the present disclosure.

### DETAILED DESCRIPTION

The following embodiments are described in detail with reference to the accompanying drawings, but the provided embodiments are not intended to limit the scope of the present disclosure. Descriptions of structural operations are not intended to limit their execution sequence. Any structure formed by recombining components and devices achieving equivalent effects shall fall within the scope of the present disclosure. Additionally, the drawings are for illustrative purposes only and are not drawn to scale. For ease of understanding, identical or similar components in the following description are labeled with the same reference numerals.

The terms used throughout the Description and Claims, unless otherwise specified, generally have their ordinary meanings in the art, in the contents of the present disclosure, and in special contents. Furthermore, the terms such as “comprising,” “including,” “having,” and “containing”, etc. used herein are open terms, i.e., mean “including but not limited to.” Additionally, the term “and/or” used herein includes any of one or more of related listed items and all combinations thereof.

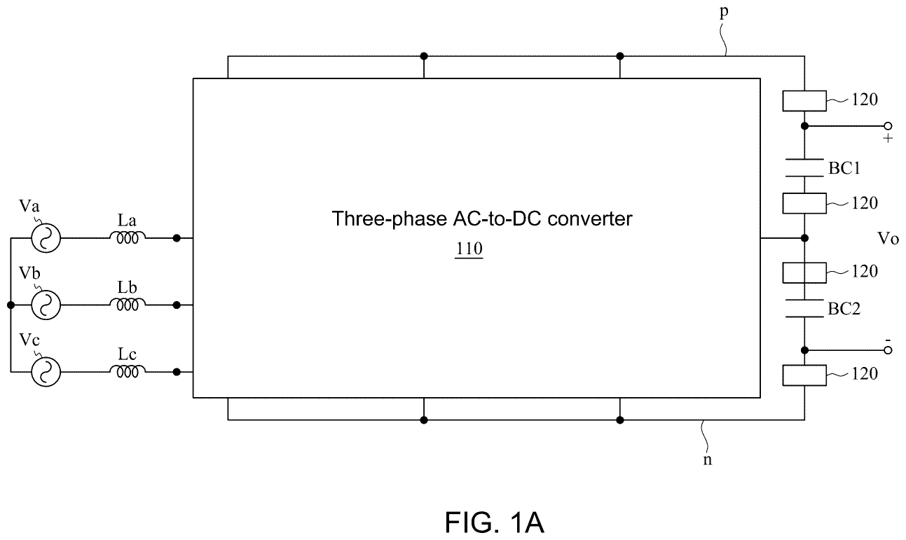

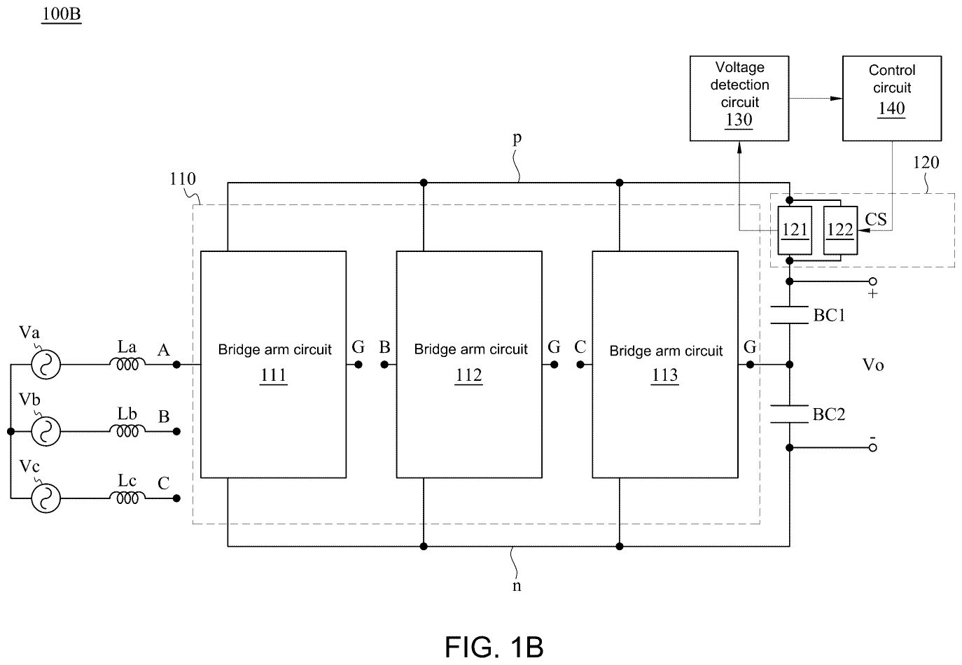

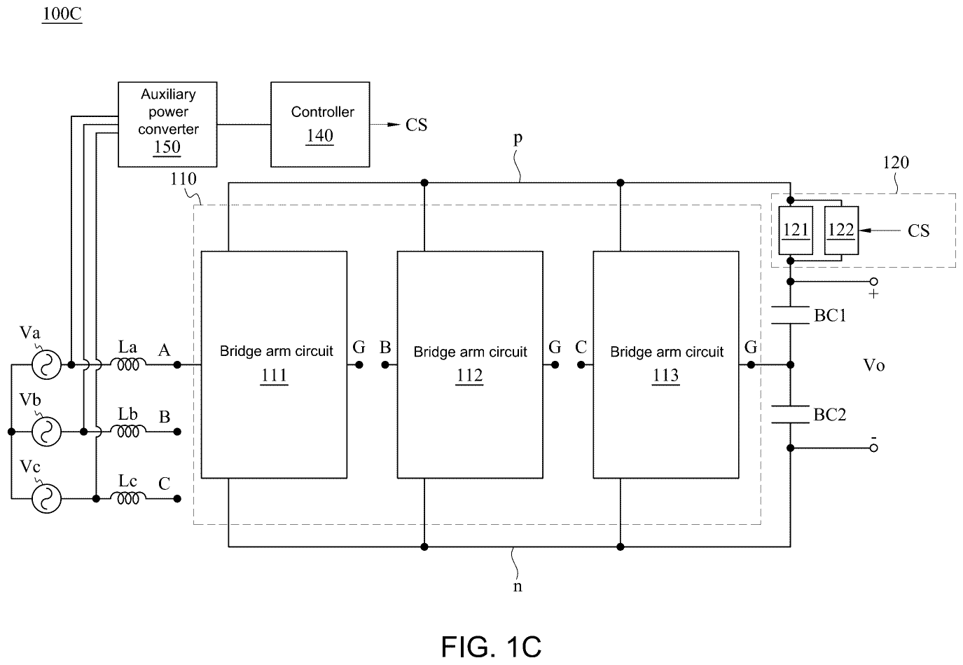

Reference is made to FIG. 1A which is a schematic diagram of a power supply system 100A according to some embodiments of the present disclosure. As shown in FIG. 1A, the power supply system 100A includes inductors La-Lc, a three-phase AC-to-DC converter 110, main capacitors BC1 and BC2, and one or more protection circuits 120. Input terminals of the three-phase AC-to-DC converter 110 are electrically connected to three phases of a three-phase power source via the inductors La-Lc to convert three-phase AC voltages Va-Vc to DC voltages which are provided through DC terminals (e.g., DC terminals p and n). In some embodiments, the three-phase AC-to-DC converter 110 may be implemented using a neutral point clamped (NPC) circuit, an active NPC circuit, a Vienna power factor correction circuit, or other suitable power conversion circuits.

In some embodiments, the main capacitors BC1 and BC2 form a DC-link circuit electrically connected between the three-phase AC-to-DC converter 110 and a load or a next-stage circuit to provide a stable DC output voltage Vo to a next-stage converter through output terminals.

The protection circuit 120 is electrically connected in series with the main capacitors BC1 and BC2 between the DC terminals p and n, and the protection circuit 120 is configured to limit inrush currents that may be generated by charging the main capacitors BC1 and BC2 during the initial application of the three-phase AC voltages Va-Vc. In some embodiments, the main capacitors BC1 and BC2 have high capacitance values, which causes an output current of the power supply system 100A to be significantly smaller than an input current on an AC side. This allows the selected specifications and quantity of devices in the protection circuit 120 to be reduced, thereby decreasing the volume of the system and lowering the costs.

In some embodiments, the protection circuit 120 may be disposed at at least one of the following four positions: between the DC terminal p and a first terminal of the main capacitor BC1, between a second terminal of the main capacitor BC1 and a neutral point G of the DC-link circuit, between the neutral point G of the DC-link circuit and a first terminal of the main capacitor BC2, and between a second terminal of the main capacitor BC2 and the DC terminal n; and a suitable number of protection circuits 120 may be disposed at at least one of the above four positions. In some embodiments, if the power supply system 100A includes N protection circuits 120 connected in series with the DC-link circuit, an inrush current during startup of the three-phase AC-to-DC converter 110 can be expressed by the following formula:

$${I}_{{inrush}_{A}} = \frac{2 * {V}_{B C}}{N * Res}$$

In the above formula, Iᵢₙᵣᵤₛₕ_{_{A}} represents the inrush current, V_{BC} represents a voltage across each of the main capacitors BC1 and BC2, Res represents a resistance value of the current-limiting element in the protection circuit 120, and N represents the number of the protection circuits 120. It should be noted that in subsequent embodiments, one protection circuit 120 will be described for simplicity, but when the power supply system 100A includes a plurality of protection circuits, it can still operate in the same or similar manner.

Reference is made to FIG. 1B which is a schematic diagram of a power supply system 100B according to some embodiments of the present disclosure. As shown in FIG. 1B, the power supply system 100B includes inductors La-Lc, a three-phase AC-to-DC converter 110, main capacitors BC1 and BC2, a protection circuit 120, a voltage detection circuit 130, and a control circuit 140. As shown in FIG. 1B, the protection circuit 120 includes a current-limiting element 121 and a bypass circuit 122.

The current-limiting element 121 is electrically connected to the main capacitors BC1 and BC2 between DC terminals p and n to suppress an inrush current that may occur during a startup operation, thereby preventing elements in the three-phase AC-to-DC converter 110 from being damaged due to an excessive current. In some embodiments, the current-limiting element 121 is a current limiting resistor, and the current limiting resistor may employ one or more suitable circuit elements such as a positive temperature coefficient thermistor, a negative temperature coefficient thermistor, or a cement resistor. In the embodiment of FIG. 1B, the protection circuit 120 is electrically connected between the DC terminal p and a first terminal of the main capacitor BC1 to suppress the inrush current flowing through output terminals.

The bypass circuit 122 is connected in parallel with the current-limiting element 121, and a resistance value of the bypass circuit 122 when being conducted is much smaller than a resistance value of the current-limiting element 121. When the startup operation is completed, the control circuit 140 sets the bypass circuit 122 to be conducted, to bypass the current-limiting element 121, such that the DC terminal p and the first terminal of the main capacitor BC1 is primarily conducted via the bypass circuit 122. In some embodiments, the bypass circuit 122 may be implemented using a suitable circuit element such as a relay or a switch.

The voltage detection circuit 130 is electrically connected to the current-limiting element 121 to detect a voltage across the current-limiting element 121. In some embodiments, the voltage detection circuit 130 may be implemented by a comparator circuit, and the voltage detection circuit 130 compares whether a voltage across both ends of the current-limiting element 121 is greater than a predetermined value, to generate a corresponding detection signal to the control circuit 140. In some embodiments, in a startup period, the voltage across both ends of the current-limiting element 121 is greater than the predetermined value, which causes an inrush current to rise (i.e., an inrush current occurs). On the other hand, after the startup operation is completed, the voltage across both ends of the current-limiting element 121 is less than the predetermined value.

The control circuit 140 is electrically connected to the voltage detection circuit 130 and generates a control signal CS based on the detection signal of the voltage detection circuit 140 to control the bypass circuit 122 to be conducted or not conducted. When the bypass circuit 122 is not conducted, the protection circuit 120 conducts current through the current-limiting element 121. When the bypass circuit 122 is conducted, since the resistance value of the bypass circuit 122 is much smaller than the resistance value of the current-limiting element 121, the protection circuit 120 conducts current primarily through the bypass circuit 122.

In some embodiments, the three-phase AC-to-DC converter 110 includes three bridge arm circuits 111-113. Input terminals of the three bridge arm circuits 111-113 are configured to respectively receive three input terminals A-C of a three-phase AC, and bridge arm circuit midpoints of the three bridge arm circuits 111-113 are connected to a neutral point G of a DC-link circuit. In some embodiments, the neutral point G of the DC-link circuit is connected to a junction between a second terminal of the main capacitor BC1 and a first terminal of the main capacitor BC2.

Reference is made to FIG. 1C which is a schematic diagram of a power supply system 100C according to some embodiments of the present disclosure. As shown in FIG. 1C, the power supply system 100C includes inductors La-Lc, a three-phase AC-to-DC converter 110, main capacitors BC1 and BC2, a protection circuit 120, a control circuit 140, and an auxiliary power converter 150. As shown in FIG. 1C, the auxiliary power converter 150 is configured to convert three-phase AC voltages Va-Vc to DC voltages to supply power to the control circuit 140. In some embodiments, when the power supply system 100C is powered on, a three-phase AC is applied to the auxiliary power converter 150, so that the auxiliary power converter 150 supplies power to the control circuit 140, and then the control circuit 140 starts to measure a duration when receiving the three-phase AC voltages, to generate a control signal CS based on the duration. In some embodiments, the duration may be set based on a startup period, such that the bypass circuit 122 is not conducted in the startup period and conducted after the startup is completed. In FIG. 1C, the operations of other elements are similar to those of corresponding elements in FIG. 1B.

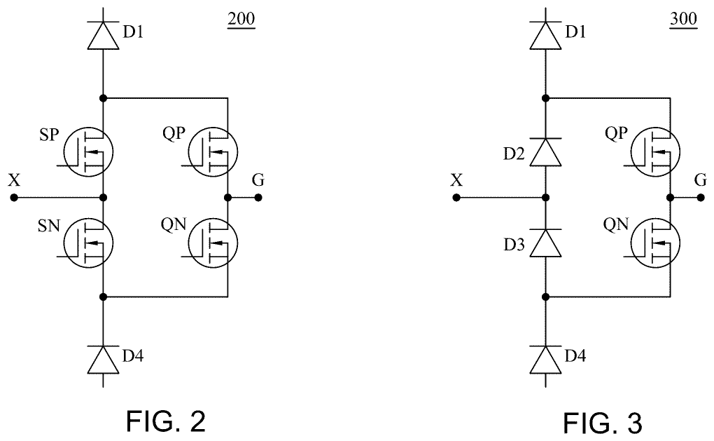

Reference is made to FIG. 2. FIG. 2 is a schematic diagram of a bridge arm circuit 200 of a three-phase AC-to-DC converter according to some embodiments of the present disclosure. In some embodiments, any one of the bridge arm circuits 111-113 of the three-phase AC-to-DC converters 110 respectively in the power supply system 100B of FIG. 1B and the power supply system 100C of FIG. 1C may be implemented by the bridge arm circuit 200 of FIG. 2, and an input terminal X in FIG. 2 corresponds to a corresponding one of the input terminals A-C of the AC power source in FIG. 1B. As shown in FIG. 2, the bridge arm circuit 200 includes switches SP, SN, QP, and QN and diodes D1 and D4. Structurally, the diodes D1, the switches SP and SN, and a diode D4 are electrically connected in series between two DC terminals of the three-phase AC-to-DC converter, and a connection point between the switches SP and SN is electrically connected to the input terminal X. The diode D1 and the switch QP are electrically connected in series between one DC terminal of the three-phase AC-to-DC converter and a neutral point G of a DC-link circuit, and the diode D4 and the switch QN are electrically connected in series between the other DC terminal of the three-phase AC-to-DC converter and the neutral point G of the DC-link circuit.

Reference is made to FIG. 3. FIG. 3 is a schematic diagram of a bridge arm circuit 300 of a three-phase AC-to-DC converter according to some embodiments of the present disclosure. In some embodiments, any one of the bridge arm circuits 111-113 of the three-phase AC-to-DC converters 110 respectively in the power supply system 100B of FIG. 1B and the power supply system 100C of FIG. 1C may be implemented by the bridge arm circuit 300 of FIG. 3, and an input terminal X in FIG. 3 corresponds to a corresponding one of the three input terminals A-C of the AC power source in FIG. 1B. As shown in FIG. 3, the bridge arm circuit 300 includes switches QP and QN and diodes D1-D4. Structurally, the diodes D1-D4 are electrically connected in series between the two DC terminals of the three-phase AC-to-DC converter, and a connection point between the diodes D2 and D3 is electrically connected to the input terminal X. The diode D1 and the switch QP are electrically connected in series between one DC terminal of the three-phase AC-to-DC converter and a neutral point G of a DC-link circuit, and the diode D4 and the switch QN are electrically connected in series between the other DC terminal of the three-phase AC-to-DC converter and the neutral point G of the DC-link circuit.

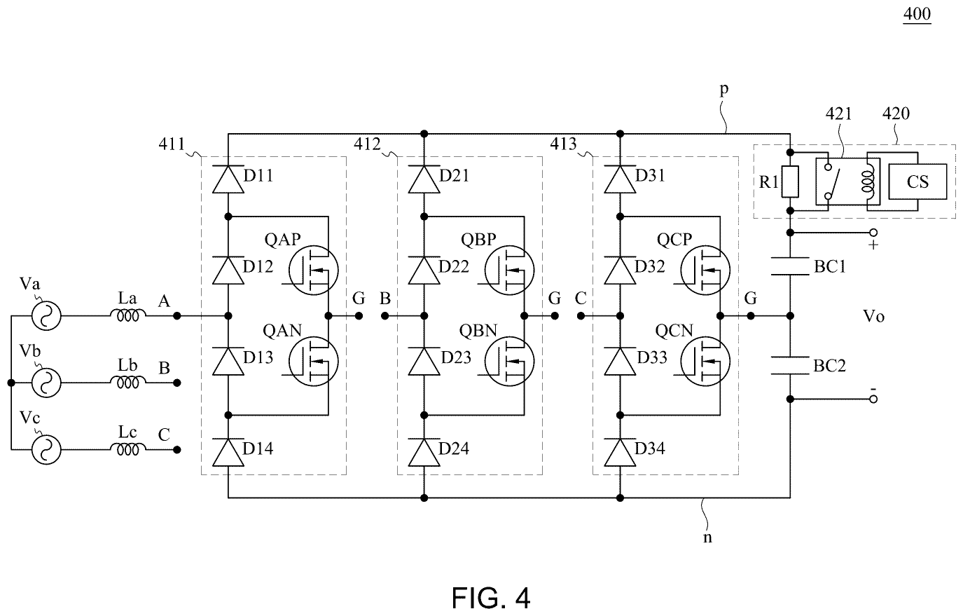

Reference is made to FIG. 4 which is a schematic diagram of a power supply system 400 according to some embodiments of the present disclosure. As shown in FIG. 4, the power supply system 400 includes inductors La-Lc, bridge arm circuits 411-413, a protection circuit 420, and main capacitors BC1 and BC2.

The bridge arm circuit 411 includes diodes D11-D14 and switches QAP and QAN. The bridge arm circuit 412 includes diodes D21-D24 and switches QBP and QBN. The bridge arm circuit 413 includes diodes D31-D34 and switches QCP and QCN. In the present embodiment, the topology of each of the bridge arm circuits 411-413 corresponds to the topology of the bridge arm circuit 300 in FIG. 3. In the embodiment of FIG. 4, the protection circuit 420 includes a current limiting resistor R1 and a relay 421.

The current limiting resistor R1 is electrically connected between a DC terminal p and the main capacitor BC1.

The relay 421 is connected in parallel with the current limiting resistor R1. In the present embodiment, the relay 421 may be implemented by a magnetically actuated relay. In this case, a control signal CS may be in a suitable signal format, such as a pulse signal format, to conduct or not conduct the relay 421. When the relay 421 is not conducted, the protection circuit 420 conducts current through the current limiting resistor R1. When the relay 421 is conducted, the protection circuit 420 conducts current primarily through the relay 421.

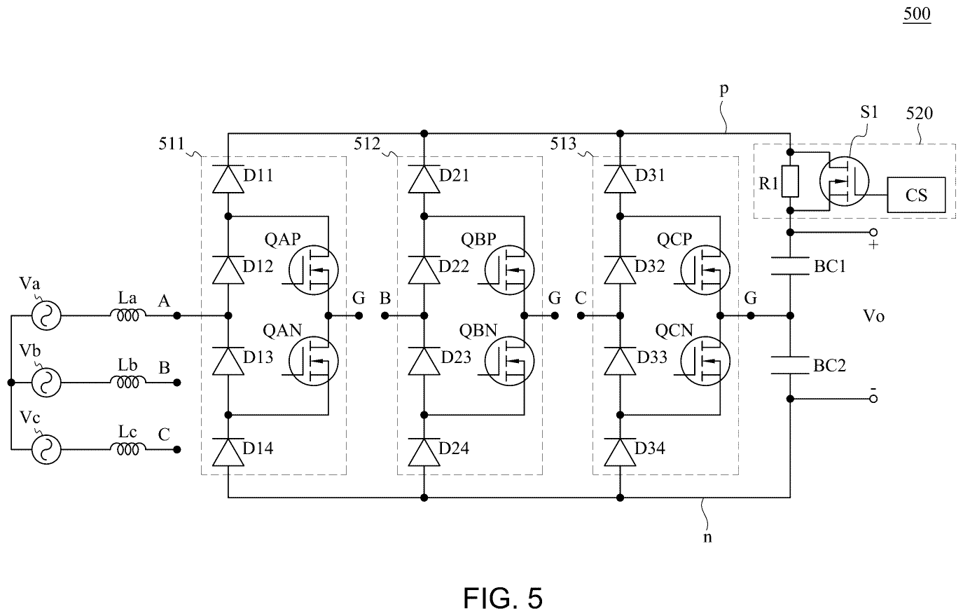

Reference is made to FIG. 5 which is a schematic diagram of a power supply system 500 according to some embodiments of the present disclosure. As shown in FIG. 5, the power supply system 500 includes inductors La-Lc, bridge arm circuits 511-513, a protection circuit 520, and main capacitors BC1 and BC2. In some embodiments, the topology of each of the bridge arm circuits 511-513 corresponds to the topology of the bridge arm circuit 300 in FIG. 3. In the embodiment of FIG. 5, the protection circuit 520 includes a current limiting resistor R1 and a switch S1.

The current limiting resistor R1 is electrically connected between a DC terminal p and the main capacitor BC1.

The switch S1 is connected in parallel with the current limiting resistor R1. The switch S1 is conducted or not conducted according to the control signal CS. When the switch S1 is not conducted, the protection circuit 520 conducts current through the current limiting resistor R1. When the switch S1 is conducted, the protection circuit 520 conducts current primarily through the switch S1.

In the above embodiments, the switches may be respectively realized with one or more BJTs, FETs, SiC transistors, GaN transistors and/or other suitable devices for providing the conduction and non-conduction functions according to the switch control signals.

In summary, the power supply system according to the present disclosure can suppress inrush currents, and due to settings on a DC side, the selected specifications and quantity of devices in the protection circuit can be reduced, thereby reducing the volume of the system, increasing the power density, and lowering the costs.

Although the present disclosure has been disclosed as above in embodiments, the embodiments are not intended to limit the present disclosure, and those of ordinary skill in the art may make some changes and embellishments within the spirit and scope of the present disclosure, therefore, the scope of protection of the present disclosure shall be defined in the attached claims.

What is claimed is:

1. A power supply system for converting three-phase AC (alternating current) voltages to DC (direct current) output voltages, comprising:
a first output terminal and a second output terminal;
a first capacitor and a second capacitor electrically connected in series between the first output terminal and the second output terminal;
three bridge arm circuits connected in parallel between a first DC terminal and a second DC terminal, each of the bridge arm circuits having an input point for receiving one of the three-phase AC voltages and electrically connected to a neutral point between the first capacitor and the second capacitor; and
a protection circuit electrically connected in series with the first capacitor and the second capacitor between the first DC terminal and the second DC terminal, wherein the protection circuit comprises:
a current-limiting element electrically connected in series with the first capacitor and the second capacitor; and
a bypass circuit connected in parallel with the current-limiting element;
a voltage detection circuit configured to detect a voltage across the current-limiting element; and
a control circuit electrically connected to the voltage detection circuit and the protection circuit, and the control circuit is configured to:
when the voltage is greater than a predetermined value, set the bypass circuit to be not conducted such that the protection circuit conducts current through the current-limiting element; and
when the voltage is less than the predetermined value, set the bypass circuit to be conducted such that the protection circuit conducts current through the bypass circuit.

2. The power supply system according to claim 1, wherein the protection circuit is disposed at one of four positions:
between the first DC terminal and a first terminal of the first capacitor;
between the second terminal of the first capacitor and the neutral point;
between the neutral point and the first terminal of the second capacitor; and
between the second terminal of the second capacitor and the second DC terminal.

3. The power supply system according to claim 1, wherein each of the three bridge arm circuits comprises:
a first diode, a first switch, a second switch and a second diode electrically connected in series between the first DC terminal and the second DC terminal;
a third switch electrically connected in series with the first diode between the first DC terminal and the neutral point; and
a fourth switch electrically connected in series with the second diode between the neutral point and the second DC terminal.

4. The power supply system according to claim 1, wherein each of the three bridge arm circuits comprises:
four diodes electrically connected in series between the first DC terminal and the second DC terminal;
a first switch electrically connected in series with one of the four diodes between the first DC terminal and the neutral point; and
a second switch electrically connected in series with another of the four diodes between the neutral point and the second DC terminal.

5. The power supply system according to claim 1, wherein the bypass circuit comprises a relay, and wherein when the voltage across the current-limiting element is greater than the predetermined value, the control circuit controls the relay to be conducted to bypass the current-limiting element.

6. The power supply system according to claim 1, wherein the bypass circuit comprises a switch, and wherein when the voltage across the current-limiting element is greater than the predetermined value, the control circuit controls the switch to be conducted to bypass the current-limiting element.

7. The power supply system according to claim 2, further comprising one or more first protection circuits disposed at one or more of the four positions:
between the first DC terminal and the first terminal of the first capacitor;
between the second terminal of the first capacitor and the neutral point;
between the neutral point and the first terminal of the second capacitor; and
between the second terminal of the second capacitor and the second DC terminal.

8. A control method of a power supply system, wherein the power supply system comprises a first output terminal and a second output terminal; a first capacitor and a second capacitor electrically connected in series between the first output terminal and the second output terminal; three bridge arm circuits connected in parallel between a first DC terminal and a second DC terminal; a protection circuit electrically connected in series with the first capacitor and the second capacitor between the first DC terminal and the second DC terminal; a voltage detection circuit; and a control circuit electrically connected to the voltage detection circuit and the protection circuit, wherein each of the bridge arm circuits has an input point for electrically connecting one of three-phase AC voltage, wherein each of the bridge arm circuits is electrically connected to a neutral point between the first capacitor and the second capacitor, wherein the protection circuit comprises a current-limiting element electrically connected in series with the first capacitor and the second capacitor and a bypass circuit connected in parallel with the current-limiting element, wherein the control method comprises:
detecting, by the voltage detection circuit, a voltage across the current-limiting element;
when the voltage is greater than a predetermined value, setting, by the control circuit, the bypass circuit to be not conducted, such that the protection circuit conducts current through the current-limiting element; and
when the voltage is less than the predetermined value, setting, by the control circuit, the bypass circuit to be conducted, such that the protection circuit conducts current through the bypass circuit.

9. A power supply system for converting three-phase AC voltages to DC output voltages, comprising:
a first output terminal and a second output terminal;
a first capacitor and a second capacitor electrically connected in series between the first output terminal and the second output terminal;
three bridge arm circuits connected in parallel between a first DC terminal and a second DC terminal, each of the bridge arm circuits having an input point for electrically connecting one of the three-phase AC voltages and electrically connected to a neutral point between the first capacitor and the second capacitor; and
a protection circuit electrically connected in series with the first capacitor and the second capacitor between the first DC terminal and the second DC terminal, wherein the protection circuit comprises:
a current-limiting element electrically connected in series with the first capacitor and the second capacitor; and
a bypass circuit connected in parallel with the current-limiting element;
a control circuit electrically connected to the protection circuit; and
an auxiliary power converter electrically connected to the control circuit and configured to convert the three-phase AC voltage to supply power to the control circuit,
wherein the control circuit starts to measure a duration when receiving the three-phase AC voltages;
when the duration is less than a predetermined period, the control circuit sets the bypass circuit to be not conducted such that the protection circuit conducts current through the current-limiting element; and
when the duration is greater than the predetermined period, the control circuit sets the bypass circuit to be conducted, such that the protection circuit conducts current through the bypass circuit.

10. The power supply system of claim 9, wherein the protection circuit is disposed at one of four positions:
between the first DC terminal and a first terminal of the first capacitor;
between the second terminal of the first capacitor and the neutral point;
between the neutral point and the first terminal of the second capacitor; and
between the second terminal of the second capacitor and the second DC terminal.

11. The power supply system of claim 9, wherein each of the three bridge arm circuits comprises:
a first diode, a first switch, a second switch, and a second diode electrically connected in series between the first DC terminal and the second DC terminal;
a third switch electrically connected in series with the first diode between the first DC terminal and the neutral point; and
a fourth switch electrically connected in series with the second diode between the neutral point and the second DC terminal.

12. The power supply system of claim 9, wherein each of the three bridge arm circuits comprises:
four diodes electrically connected in series between the first DC terminal and the second DC terminal;
a first switch electrically connected in series with one of the four diodes between the first DC terminal and the neutral point; and
a second switch electrically connected in series with another of the four diodes between the neutral point and the second DC terminal.

13. The power supply system of claim 9, wherein the bypass circuit comprises a relay, and wherein when the voltage across the current-limiting element is greater than the predetermined value, the control circuit controls the relay to be conducted to bypass the current-limiting element.

14. The power supply system of claim 9, wherein the bypass circuit comprises a switch, and wherein when the voltage across the current-limiting element is greater than the predetermined value, the control circuit controls the switch to be conducted to bypass the current-limiting element.

15. The power supply system of claim 10, further comprising one or more first protection circuits disposed at one or more of the four positions:
between the first DC terminal and the first terminal of the first capacitor;
between the second terminal of the first capacitor and the neutral point;
between the neutral point and the first terminal of the second capacitor; and
between the second terminal of the second capacitor and the second DC terminal.
